(19) United States
(12) Patent Application Publication
(10) Pub. No.: US 2026/0303745 A1
(43) Pub. Date: Oct. 1, 2026

(54) IMAGE READING DEVICE

(71) Applicant: SEIKO EPSON CORPORATION, TOKYO (JP)

(72) Inventors: Ryota HAYASHIDA, MUNAKATA-SHI (JP); Masaki NAMIKI, KITAKYUSHU-SHI (JP)

(21) Appl. No.: 19/635,930

(22) Filed: Apr. 1, 2026

(30) Foreign Application Priority Data
Apr. 1, 2025 (JP) 2025-060410

(51) Int. Cl. H04N 1/00; A46B 15/00

(52) U.S. Cl. CPC H04N 1/00909; A46B 15/0051; A46B 15/0053; A46B 2200/3073; H04N 2201/0081

(57) ABSTRACT

An image reading device 1 includes a transport path 3 along which a medium is transported, a reading section 5, a lower unit 71, an upper unit 72 that is provided so as to be openable and closable with respect to the lower unit 71, and that is configured to form a part of the transport path 3 with the lower unit 71 in a closed state, a cleaning section 100 configured to pass an airflow for removing foreign matter on the reading section 5 through a vent hole 113, and an airflow generation section 140 configured to generate airflow in the cleaning section 100, wherein the cleaning section 100 is connected to the airflow generation section 140 at a fixed end 122 and is configured to remove foreign matter on the reading section 5 by airflow from the vent hole 113 provided at a free end 121.

The present application is based on, and claims priority from JP Application Serial Number 2025-060410, filed Apr. 1, 2025, the disclosure of which is hereby incorporated by reference herein in its entirety.

### BACKGROUND

### 1. Technical Field

The present disclosure relates to an image reading device.

### 2. Related Art

In the related art, various image reading devices have been used that use a reading section of a reading unit to read an image on a transported medium. In such an image reading device, foreign matter such as paper dust may remain on or adhere to the reading section. Therefore, for example, JP-A-2006-270707 discloses an image reading device including a suction fan and a plurality of elongated holes as suction ports, and a guide member capable of sucking, from the plurality of elongated holes, paper dust on a contact glass of a document reading section.

The image reading device disclosed in JP-A-2006-270707 can suck the paper dust at a position opposing the suction port. However, the guide member as the suction mechanism is fixed, and it is difficult to collect the paper dust that is distant from the suction port. Therefore, even if foreign matter on the reading section is to be cleaned by the fixed suction mechanism, foreign matter adhering to the reading section may not be cleaned suitably. When foreign matter adheres to the reading section, a streak may occur in a read image due to foreign matter.

### SUMMARY

An image reading device of the present disclosure for solving the above problems includes a transport path along which a medium is transported; a reading section configured to read an image of the transported medium; a lower unit; an upper unit that is provided so as to be openable and closable with respect to the lower unit by pivoting around a pivot shaft and that is configured to form a part of the transport path with the lower unit in a closed state; a cleaning section configured to pass an airflow for removing foreign matter adhering to the reading section through a vent hole; and an airflow generation section configured to generate the airflow in the cleaning section, wherein the cleaning section is connected to the airflow generation section at a fixed end and is configured to remove foreign matter adhering to the reading section by the airflow at the vent hole, which is provided at a free end opposite to the fixed end.

### BRIEF DESCRIPTION OF THE DRAWINGS

FIG. 1 is a side cross-sectional view of an image reading device according to a first embodiment of the present disclosure.

FIG. 2 is a perspective view of the image reading device of FIG. 1 when an upper unit is in a closed state with respect to a lower unit.

FIG. 3 is a perspective view of the image reading device of FIG. 1 when the upper unit is in the closed state with respect to the lower unit, as viewed from an angle different from that in FIG. 2.

FIG. 4 is a perspective view of the image reading device of FIG. 1 when the upper unit is in an open state with respect to the lower unit.

FIG. 5 is a perspective view of the image reading device of FIG. 1 when the upper unit is in the open state with respect to the lower unit, as viewed from an angle different from that in FIG. 4.

FIG. 6 is a perspective view illustrating the periphery of a brush section of the cleaning section of the image reading device of FIG. 1.

FIG. 7 is a perspective view illustrating a state in which foreign matter adhering to a reading section is removed by the brush section in the image reading device of FIG. 1.

FIG. 8 is a perspective view illustrating the periphery of an airflow generation section of a cleaning section with a part of a housing of the image reading device in FIG. 1 removed.

FIG. 9 is a rear view illustrating the periphery of the airflow generation section of the cleaning section of the image reading device of FIG. 1, with a plate, a part of the housing, and the like further removed from the state of FIG. 8.

FIG. 10 is a perspective view illustrating the image reading device of FIG. 1 as viewed from the back surface side, in a state where a cover member is attached.

FIG. 11 is a perspective view illustrating the image reading device of FIG. 1 as viewed from the back surface side, in a state where the cover member is removed and a collection section constituting the airflow generation section is attached.

FIG. 12 is a perspective view illustrating the image reading device of FIG. 1 as viewed from the back surface side, in a state where the cover member is removed and a collection section constituting the airflow generation section is removed.

FIG. 13 is a flowchart showing an example of a cleaning operation performed using the image reading device in FIG. 1.

FIG. 14 is a perspective view illustrating the periphery of the airflow generation section of the cleaning section in the image reading device according to a second embodiment of the present disclosure, with a part of the housing removed.

### DESCRIPTION OF EMBODIMENTS

First, the present disclosure will be schematically described.

An image reading device according to a first aspect of the present disclosure for solving the above problems includes a transport path along which a medium is transported; a reading section configured to read an image of the transported medium; a lower unit; an upper unit that is provided so as to be openable and closable with respect to the lower unit by pivoting around a pivot shaft and that is configured to form a part of the transport path with the lower unit in a closed state; a cleaning section configured to pass an airflow for removing foreign matter adhering to the reading section through a vent hole; and an airflow generation section configured to generate the airflow in the cleaning section, wherein the cleaning section is connected to the airflow generation section at a fixed end and is configured to remove foreign matter adhering to the reading section by the airflow at the vent hole, which is provided at a free end opposite to the fixed end.

According to the present aspect, the cleaning section configured to pass the airflow for removing foreign matter adhering to the reading section through the vent hole and the airflow generation section configured to generate airflow in the cleaning section, wherein the cleaning section is connected to the airflow generation section at a fixed end and is configured to remove foreign matter adhering to the reading section by the airflow from the vent hole provided at a free end opposite to the fixed end. With such a configuration, since the free end of the cleaning section can be operated separately from the airflow generation section, the number of cleanable portions increases, and a portion that a user wants to clean can be cleaned with pinpoint accuracy. Therefore, foreign matter adhering to the reading section can be suitably removed.

The image reading device according to a second aspect of the present disclosure is an aspect dependent on the first aspect, wherein the cleaning section is configured to remove foreign matter adhering to the transport path when the upper unit is in an open state.

According to the present aspect, the cleaning section is configured to remove foreign matter adhering to the transport path when the upper unit is in the open state. With such a configuration, since the cleaning section can clean foreign matter adhering to the transport path in addition to that adhering to the reading section, it is possible to suppress foreign matter from adhering to the reading section due to foreign matter adhering to the transport path moving to the reading section by the transport of the medium.

The image reading device according to a third aspect of the present disclosure is an aspect dependent on the first or second aspect, wherein the cleaning section includes a handle section that is provided at the free end and that has the vent hole and a flexible member that connects the airflow generation section and the handle section.

According to this aspect, the cleaning section includes a handle section provided at the free end and having the vent hole and a flexible member connecting the airflow generation section and the handle section. With such a configuration, the user can easily grip the cleaning section and easily perform the cleaning operation.

The image reading device according to a fourth aspect of the present disclosure is an aspect dependent on the third aspect, wherein the flexible member has a length that allows cleaning of a portion of the reading section farthest from the fixed end in a width direction along a longitudinal direction of the reading section.

According to the present aspect, the flexible member has a length that allows cleaning of a portion of the reading section farthest from the fixed end in the width direction. With such a configuration, at least the entire region of the reading section can be cleaned, and for example, the occurrence of streaks in a read image due to foreign matter can be suppressed.

The image reading device according to a fifth aspect of the present disclosure is an aspect depending on the fourth aspect, further including a placement section that is provided so as to be capable of being raised and lowered in a vertical direction and on which the medium to be transported to the transport path is placed, wherein the flexible member has a length that allows cleaning of a portion of the transport path or the placement section farthest from the fixed end.

According to the present aspect, the image reading device includes the placement section that is provided so as to be capable of being raised and lowered in a vertical direction and on which the medium to be transported to the transport path is placed, wherein the flexible member has a length that allows cleaning of a portion of the transport path or the placement section farthest from the fixed end. With such a configuration, the entire region of the transport path or the placement section can be cleaned in addition to the reading section.

The image reading device according to a sixth aspect of the present disclosure is an aspect depending on any one of the third to fifth aspects, wherein the handle section has a brush section at a distal end of the handle section and the brush section is disposed around the vent hole.

According to this aspect, the handle section has the brush section at the distal end and the brush section is disposed around the vent hole. With such a configuration, for example, it is possible to scrape out foreign matter that has entered the gap of the transport path or the reading section, and it is possible to reduce the remaining foreign matter.

The image reading device according to a seventh aspect of the present disclosure is an aspect depending on any one of the first to sixth aspects, further including a housing, wherein the housing includes an accommodation section configured to accommodate the cleaning section inside the housing and a door section configured to cover the accommodation section in a state where the cleaning section is accommodated.

According to the present aspect, a housing, wherein the housing includes the accommodation section configured to accommodate the cleaning section therein and the door section configured to cover the accommodation section in a state where the cleaning section is accommodated. With such a configuration, the cleaning section does not protrude to the outside of the housing, and it is possible to prevent the cleaning section from interfering with the operation of the user when the cleaning section is not used.

The image reading device according to an eighth aspect of the present disclosure is an aspect depending on any one of the first to seventh aspects, further including an operation section configured receive a cleaning instruction, wherein a first cleaning mode, a second cleaning mode, and a third cleaning mode are executable in order of weaker airflow generated by the airflow generation section and when the operation section receives a cleaning instruction, the operation section is configured to display a selection of modes that select one of the first cleaning mode, the second cleaning mode, and the third cleaning mode.

According to the present aspect, an operation section configured receive a cleaning instruction, wherein when the operation section receives the cleaning instruction, the operation section is configured to display a selection of modes that select one of the first cleaning mode, the second cleaning mode, and the third cleaning mode. With such a configuration, at least three modes can be selected, and the user can select an appropriate mode according to the amount of foreign matter and the position of foreign matter, thereby improving the cleaning efficiency.

The image reading device according to a ninth aspect of the present disclosure is an aspect depending on any one of the first to eighth aspects, wherein the airflow generation section includes a fan configured to generate the airflow, and a duct configured to connect the fixed end and the fan.

According to the present aspect, the airflow generation section includes the fan configured to generate the airflow, and the duct configured to connect the fixed end of the cleaning section and the fan. With such a configuration, since the fan can be disposed at a position distant from the fixed end of the cleaning section, the degree of freedom of the arrangement of the fan is increased.

The image reading device according to a tenth aspect of the present disclosure is an aspect dependent on the ninth aspect, wherein the fan is provided at a position closer to the fixed end than a half of a width of the image reading device in the width direction along a longitudinal direction of the reading section.

According to the present aspect, the fan is provided at a position closer to the fixed end than the half of the width of the image reading device in the width direction. With such a configuration, the distance between the fan and the fixed end of the cleaning section, that is, the length of the duct can be shortened, and the strength of the airflow in the vent hole can be prevented from being weakened, so that the cleaning efficiency can be improved.

The image reading device according to an eleventh aspect of the present disclosure is an aspect dependent on the ninth or tenth aspect, wherein the airflow generation section is configured to generate the airflow to be sucked through the vent hole.

According to this aspect, the airflow generation section is configured to generate the airflow to be sucked through the vent hole. With such a configuration, foreign matter can be sucked in one direction, and cleaning can be performed without scattering foreign matter around.

The image reading device according to a twelfth aspect of the present disclosure is an aspect depending on the eleventh aspect, wherein the airflow generation section includes a collection section configured to collect foreign matter sucked from the cleaning section and the collection section is disposed between the duct and the fan.

According to the present aspect, the airflow generation section includes the collection section configured to collect foreign matter sucked from the cleaning section and the collection section is disposed between the duct and the fan. With such a configuration, it is possible to suppress the adhesion of foreign matter to the fan, and it is possible to suppress the decrease in the suction force due to the adhesion of foreign matter to the fan.

The image reading device according to a thirteenth aspect of the present disclosure is an aspect depending on the twelfth aspect, further including a housing configured to accommodate the collection section therein, wherein the collection section is configured to attach to and detach from the housing by being pulled out from an opening provided in a back surface of the housing along a depth direction that is a direction intersecting an axial direction of the pivot shaft and is a direction from a front surface of the housing toward the back surface.

According to the present aspect, the image reading device includes the housing configured to accommodate the collection section therein, wherein the collection section is attachable to and detachable from the housing by being pulled out from the opening provided on the back surface of the housing along the depth direction. With such a configuration, the collection section can be easily cleaned or replaced without disassembling the device. Since the cleaning section can be continuously used by cleaning or replacing the collection section, for example, it is possible to reduce the number of times of handling by a service person or the like and it is possible to use the cleaning section for a long period of time.

The image reading device according to a fourteenth aspect of the present disclosure is an aspect depending on the thirteenth aspect, wherein the opening is covered with a cover member.

According to this aspect, the opening is covered with the cover member. With such a configuration, it is possible to suppress foreign matter collected in the collection section from being diffused to the outside from the opening.

The image reading device according to a fifteenth aspect of the present disclosure is an aspect depending on the ninth aspect, wherein the airflow generation section is configured to generate the airflow to be discharged from the vent hole.

According to this aspect, the airflow generation section is configured to generate the airflow to be discharged from the vent hole. With such a configuration, when the adhesion of foreign matter to the transport path or the reading section is light, for example, when a small amount of foreign matter adhering to the reading section is to be removed, foreign matter can be moved to a place other than the reading section by blowing the airflow to foreign matter.

### First Embodiment

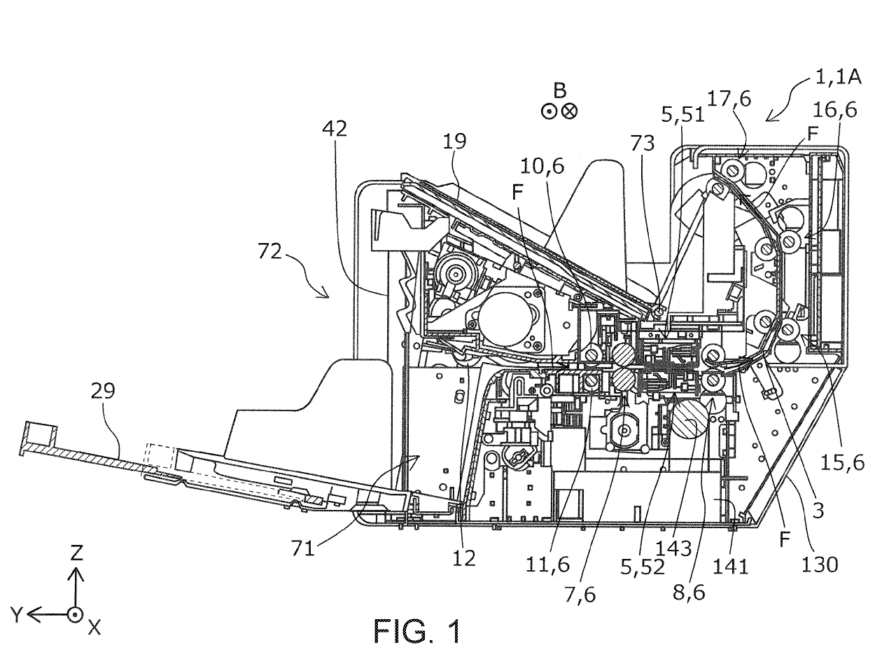

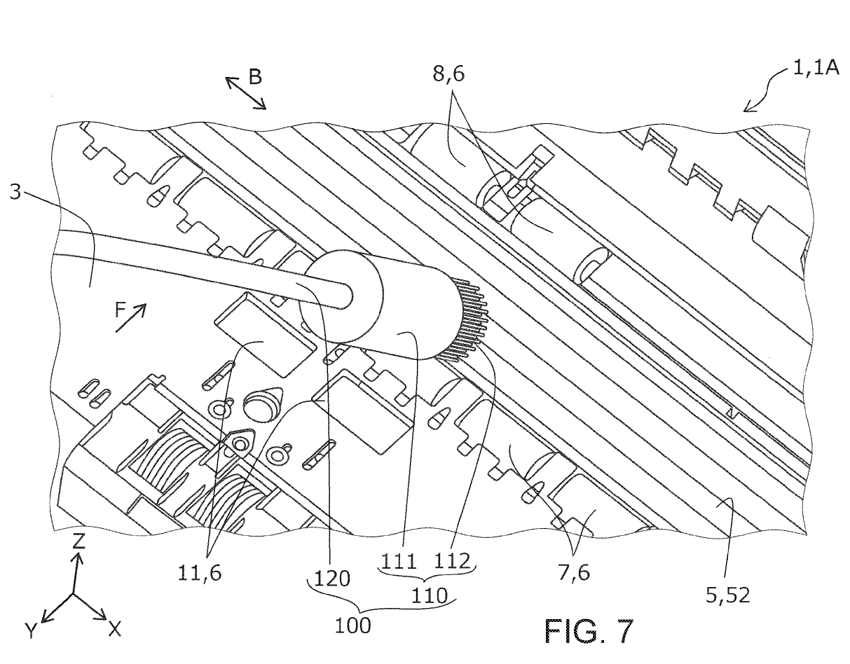

Hereinafter, an image reading device 1A as an embodiment of an image reading device 1 will be described with reference to FIGS. 1-9. First, an outline of the image reading device 1A according to a first embodiment will be described with reference to FIG. 1. In the following description, three axes orthogonal to each other are referred to as an X-axis, a Y-axis, and a Z-axis, respectively, as illustrated in each drawing. The direction indicated by the arrows of the three axes (X, Y, and Z) is the +direction of each direction, and the opposite direction is the -direction. The Z-axis direction corresponds to a vertical direction, that is, a direction in which gravity acts, a +Z direction indicates a vertically upward direction, and a -Z direction indicates a vertically downward direction. The X-axis direction and the Y-axis direction correspond to a horizontal direction, and the X-axis direction corresponds to a width direction B. The +Y direction indicates the front direction of the device, and the -Y direction indicates the rear direction of the device. The +X direction indicates the right direction of the device, and the -X direction indicates the left direction of the device.

The image reading device 1A of the present embodiment is a document scanner capable of reading images formed on a medium. Here, the image formed on the medium means an image visually recorded on the medium, and is, for example, a character, a figure, a table, a picture, a photograph, or the like. The medium is not limited to sheets, but also includes cards, booklets, or the like. The image reading device 1A is not limited to a scanner, and may be a copier, a facsimile machine, or the like.

The image reading device 1A transports medium placed on a feed tray 29 in a transport direction F along a transport path 3, and reads images on the transported medium with a reading unit 5 as a reading section. As illustrated in FIG. 1, the image reading device 1A includes two reading sections, that is, a first reading unit 51 and a second reading unit 52 as reading units 5 that read images on the medium. The first reading unit 51 is positioned above the transport path 3 and reads an image on a first surface of the medium. The second reading unit 52 is positioned below the transport path 3 and reads an image on a second surface opposite to the first surface. The reading unit 5 is configured by, for example, a Contact Image Sensor (CIS) type sensor, a Charge Coupled Device (CCD) type sensor, or the like.

The image reading device 1A includes a transport section 6 that transports the medium in the transport direction F along the transport path 3. The image reading device 1A includes, as the transport section 6, a transport roller pair 7 provided upstream of the first reading unit 51 and the second reading unit 52, and a transport roller pair 8 provided downstream of the first reading unit 51 and the second reading unit 52. The transport roller pair 7 and the transport roller pair 8 are configured by a pair of a driving roller and a driven roller that are rotated by the power of a drive source such as a motor (not illustrated).

A feeding section 10 and a separation section 11 are disposed upstream of the transport roller pair 7 in the transport direction F. The feeding section 10 is rotated by the power of a motor (not illustrated) and transports the medium in the transport direction F. The separation section 11 includes a torque limiter, includes a separation roller that is rotated by the power of a motor (not illustrated), and can separate one sheet of medium from plural sheets of medium. A pickup roller 12 is disposed upstream of the separation section 11 in the transport direction F. The pickup roller 12 is a drive roller that rotates by the power of a motor (not illustrated), picks up the medium, and sends out the medium in the transport direction F.

The image reading device 1A is provided with a straight path from the feeding section 10 to the transport roller pair 8 and a U-turn path positioned downstream of the straight path. In the U-turn path, a transport roller pair 15, a transport roller pair 16, and a discharge roller pair 17 as the transport section 6 are disposed in this order along the transport direction F. The transport roller pair 15, the transport roller pair 16, and the discharge roller pair 17 are also configured by a pair of a driving roller and a driven roller that are rotated by the power of a motor (not illustrated). The image reading device 1A includes a discharge tray 19 that receives the medium discharged from the discharge roller pair 17.

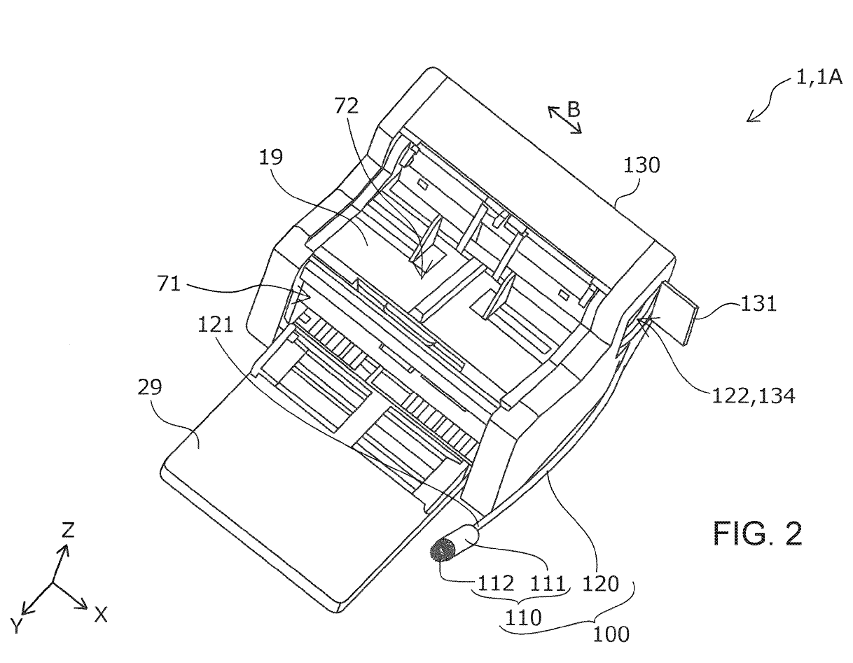

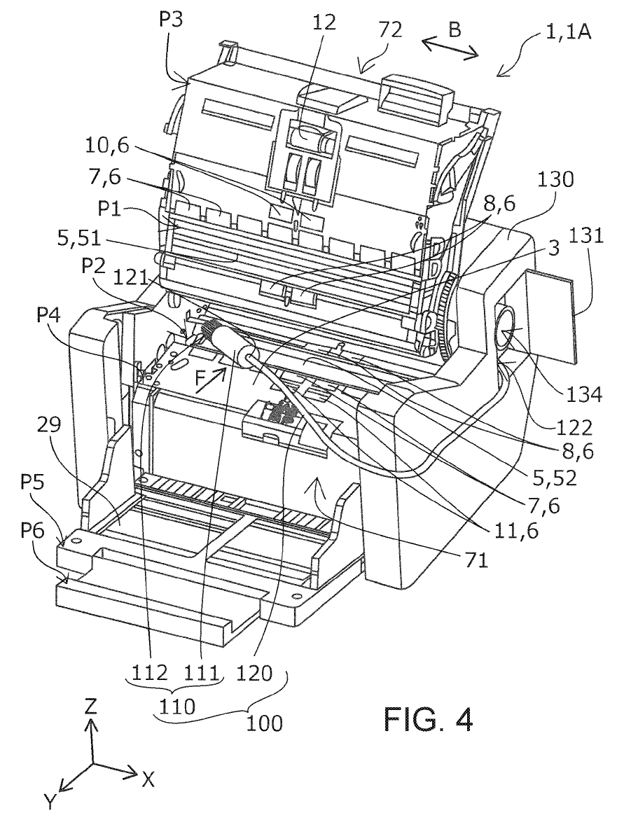

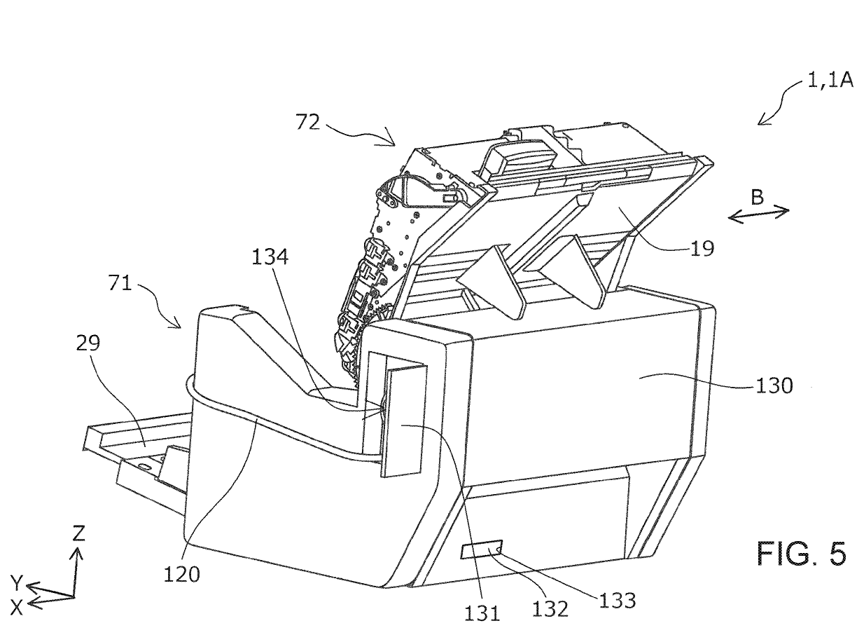

Next, the configuration of the image reading device 1A will be further described with reference to FIGS. 2-5 in addition to FIG. 1. As illustrated in FIGS. 1-5, the image reading device 1A includes a lower unit 71 and an upper unit 72. The upper unit 72 is provided so as to be openable and closable with respect to the lower unit 71 by pivoting around a pivot shaft 73 illustrated in FIG. 1. FIGS. 1-3 illustrate a state where the upper unit 72 is in a closed state with respect to the lower unit 71. On the other hand, FIGS. 4 and 5 illustrate a state where the upper unit 72 is in an open state with respect to the lower unit 71. When the upper unit 72 is in the closed state with respect to the lower unit 71, the upper unit 72 forms a part of the transport path 3 together with the lower unit 71.

Note that in the lower unit 71, the separation section 11, one roller of the transport roller pair 7, the second reading unit 52 of the reading unit 5, and one roller of the transport roller pair 8 are provided in this order in the transport direction F. On the other hand, the upper unit 72 is provided with the feeding section 10, the other roller of the transport roller pair 7, the first reading unit 51 of the reading unit 5, and the other roller of the transport roller pair 8 in this order in the transport direction F.

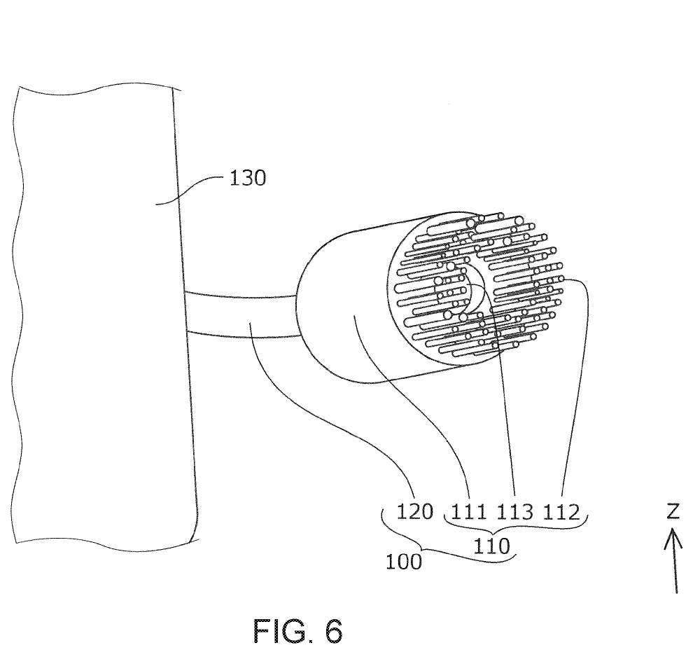

As described above, the image reading device 1A of the present embodiment includes the transport path 3 along which medium is transported, the reading unit 5 that reads images on the transported medium, the lower unit 71, and the upper unit 72. As will be described later, the image reading device 1A of the present embodiment includes a cleaning section 100 capable of passing, from a vent hole 113, an airflow for removing foreign matter adhering to the reading unit 5 and an airflow generation section 140 that generates the airflow in the cleaning section 100. The airflow generation section 140 can also be regarded as a component of the cleaning section 100. Therefore, the cleaning section 100 and the airflow generation section 140 will be described in detail below with reference to FIGS. 6-13 in addition to FIGS. 1-15.

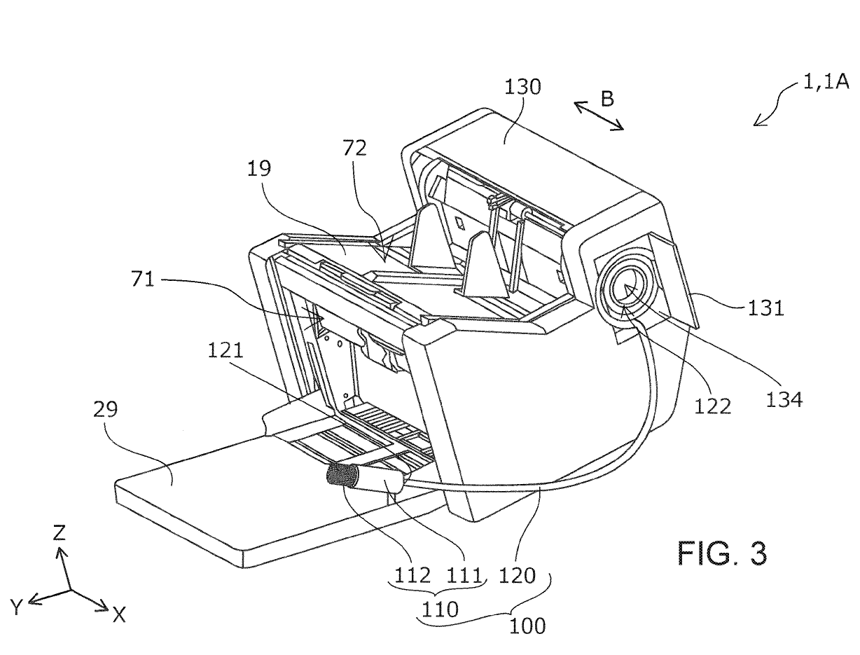

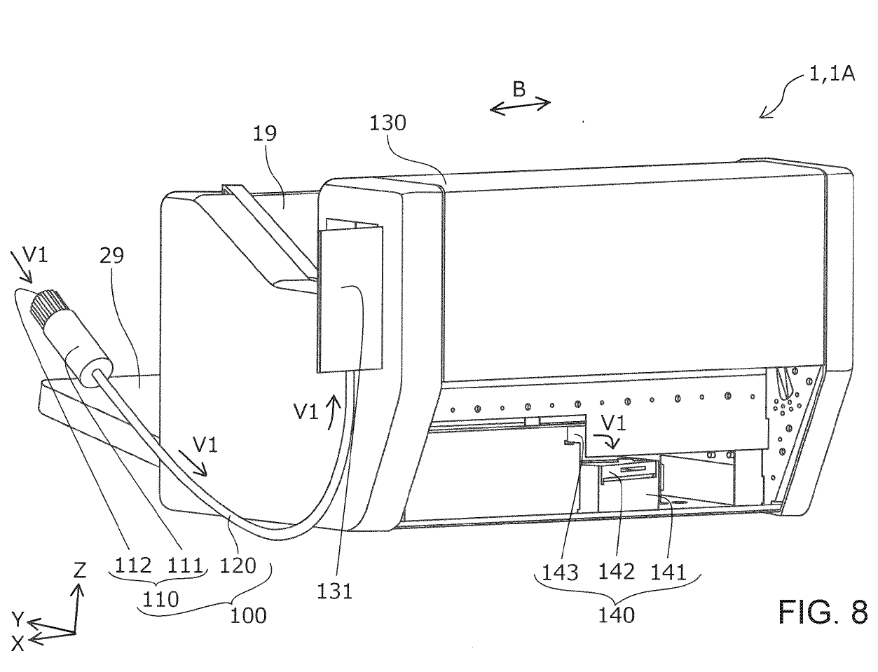

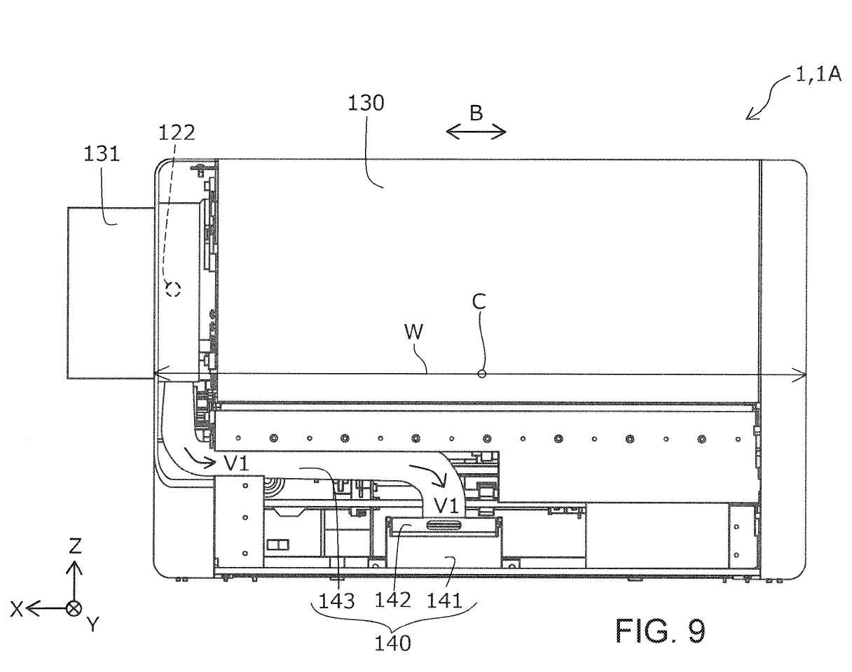

In the image reading device 1A of the present embodiment, the cleaning section 100 is connected to the airflow generation section 140 illustrated in FIGS. 8 and 9 at a fixed end 122 of a rubber tube 120 as an example of a flexible member as illustrated in FIGS. 3 and 4. As shown in FIGS. 3 and 4, a head section 110 is connected to a free end 121, which is the opposite end to the fixed end 122 of the tube 120, which is a flexible member. As illustrated in FIG. 6, the head section 110 is provided with the vent hole 113, and is configured to be able to remove foreign matter adhering to the reading unit 5 by the airflow from the vent hole 113.

The image reading device 1A of the present embodiment is configured as described above, thereby the free end 121 of the cleaning section 100 can be operated separately from the airflow generation section 140. Therefore, the number of cleanable portions increases, and the user can clean a portion that the user wants to clean with pinpoint accuracy. Therefore, the image reading device 1A of the present embodiment can suitably remove foreign matter adhering to the reading unit 5.

As illustrated in FIGS. 4 and 5, the cleaning section 100 can, in a case where the upper unit 72 is in the open state, remove foreign matter adhering to the transport path 3. With such a configuration, the cleaning section 100 can clean foreign matter adhering to the transport path 3 in addition to that adhering to the reading unit 5, and thus it is possible to suppress foreign matter from adhering to the reading unit 5 by foreign matter that adheres to the transport path 3 moving to the reading unit 5 during transport of the medium.

Here, as illustrated in FIGS. 2-4 and 6-8, the cleaning section 100 has the head section 110 and the tube 120, which is a flexible member. The head section 110 has a handle section 111 having the vent hole 113 at the free end 121 of the tube 120. The tube 120 connects the airflow generation section 140 and the handle section 111. With the configuration having the handle section 111, the user can easily grip the cleaning section 100 and easily perform the cleaning operation.

Note that the tube 120 has, in the width direction B along the longitudinal direction of the reading unit 5, a length that allows cleaning of a portion of the reading unit 5 farthest from the fixed end 122. For example, the length is such that the position P1 and the position P2 in FIG. 4, which are an example of the portion of the reading unit 5 farthest from the fixed end 122, can be cleaned. With such a configuration, at least the entire region of the reading unit 5 can be cleaned, and for example, the occurrence of streaks in the read image due to foreign matter can be suppressed.

As described above, the image reading device 1A of the present embodiment includes the feed tray 29. The feed tray 29 is a placement section that is provided so as to be able to be raised and lowered in the vertical direction (Z-axis direction) and on which the medium to be transported to the transport path 3 is placed. The tube 120 has a length that allows cleaning of a portion of the transport path 3 that is farthest from the fixed end 122 and a portion of the feed tray 29 that is farthest from the fixed end 122. For example, the length is such that the position P3 and the position P4 in FIG. 4, which are examples of portions of the transport path 3 farthest from the fixed end 122, can be cleaned. For example, the length is such that the position P5 and the position P6 in FIG. 4, which are examples of portions of the feed tray 29 farthest from the fixed end 122, can be cleaned.

As described above, it is desirable that the tube 120 has a length that enables cleaning of a portion of the transport path 3 or the feed tray 29 that is farthest from the fixed end 122. This is because the entire region of the transport path 3 or the feed tray 29 can be cleaned in addition to the reading unit 5. The entire region of the transport path 3 includes, for example, a region of the transport path 3 farthest from the fixed end 122 when the upper unit 72 is in the open state with respect to the lower unit 71.

As illustrated in FIG. 6 and the like, the handle section 111 includes a brush section 112 at a distal end of the handle section 111. As illustrated in FIG. 6, the brush section 112 is disposed around the vent hole 113. With such a configuration, for example, it is possible to scrape out foreign matter that has entered the gap of the transport path 3 or the reading unit 5, and it is possible to reduce the remaining foreign matter.

As illustrated in FIGS. 1-5 and 8-12, the image reading device 1A according to the present embodiment includes a housing 130. As illustrated in FIGS. 3 and 4, the housing 130 has an accommodation section 134 capable of accommodating the head section 110 and the tube 120 of the cleaning section 100 inside the housing 130, and a door section 131 capable of covering the accommodation section 134 in a state where the head section 110 and the tube 120 of the cleaning section are accommodated.

With such a configuration, the cleaning section 100 does not protrude to the outside the housing 130, and it is possible to prevent the cleaning section 100 from interfering with the operation of the user when the cleaning section 100 is not used. However, it is not limited to such a configuration, and for example, as a configuration that can be optionally attached to the housing 130, a configuration in which the accommodation section 134 of the cleaning section 100 is provided outside the housing 130 may be adopted. The accommodation section 134 may be disposed at a position inside the housing 130, which appears when the upper unit 72 is in the open state with respect to the lower unit 71.

As illustrated in FIG. 1, the image reading device 1A of the present embodiment includes an operation panel 42 as an operation section that can receive an instruction from the user and can display various pieces of information. The operation panel 42 can receive a cleaning instruction from the user. The image reading device 1A of the present embodiment can execute the first cleaning mode, the second cleaning mode, and the third cleaning mode in the order of a weaker airflow generated by the airflow generation section 140.

When the operation panel 42 receives a cleaning instruction from the user, the operation panel 42 can display a selection of modes that select one of the first cleaning mode, the second cleaning mode, and the third cleaning mode. With the image reading device 1A of the present embodiment having such a configuration, at least three modes can be selected, and the user can select an appropriate mode according to the amount of foreign matter and the position of foreign matter.

Here, the first cleaning mode can be an energy saving mode in which, for example, importance is placed on low power consumption and low noise although the suction force is weak, and the purpose is to suck light foreign matter such as paper dust and dirt. The second cleaning mode is, for example, a normal cleaning mode in which paper dust, dust, and the like can be sucked as foreign matter, and in addition, a mode in which foreign matter such as rubber pieces that are slightly larger and heavier than foreign matter can also be sucked. The third cleaning mode is, for example, a strong suction force mode capable of sucking foreign matter accumulated in small and narrow regions such as a gap or a corner where the entire head section 110 cannot be inserted.

As illustrated in FIGS. 8 and 9, the airflow generation section 140 includes a fan 141 that generates the airflow and a duct 143 that connects the fixed end 122 and the fan 141. By configuring the airflow generation section 140 in this manner, the fan 141 can be disposed at a position distant from the fixed end 122 of the cleaning section 100, thereby increasing the degree of freedom of the arrangement of the fan 141.

As illustrated in FIG. 9, the fan 141 is provided at a position closer to the fixed end 122 than a position C at half of the width W of the image reading device 1A in the width direction B along the longitudinal direction of the reading unit 5. In other words, the fan 141 is provided so as to be closer to the side on which the fixed end 122 of the duct 143 is provided.

With such a configuration, the distance between the fan 141 and the fixed end 122 of the cleaning section 100, that is, the length of the duct 143, can be suitably reduced to be shorter than the width W of the image reading device 1A. Therefore, it is possible to suppress the intensity of the airflow in the vent hole 113 from being weakened, and it is possible to improve the cleaning efficiency. However, although the above described effect can be obtained by adopting such a configuration, the present disclosure is not limited to such a configuration, and includes a configuration in which the fan 141 is provided at a position farther from the fixed end 122 than the position C at half of the width W of the image reading device 1A.

In the image reading device 1A of the present embodiment, the airflow generation section 140 is configured to generate the airflow to be sucked through the vent hole 113. As illustrated in FIG. 8, the airflow flows from the vent hole 113 to the fan 141 through the tube 120 and the duct 143 in a suction direction V1. By the image reading device 1A of the present embodiment being configured as described above, foreign matter can be sucked in one direction and cleaning can be performed without scattering foreign matter around.

As illustrated in FIGS. 8, 9, 11, and 12, the airflow generation section 140 includes a filter 142 as a collection section that collects foreign matter sucked from the vent hole 113 of the cleaning section 100. The filter 142 is disposed between the duct 143 and the fan 141. With such a configuration, it is possible to suppress adhesion of foreign matter to the fan 141, and it is possible to suppress a decrease in suction force due to adhesion of foreign matter to the fan 141.

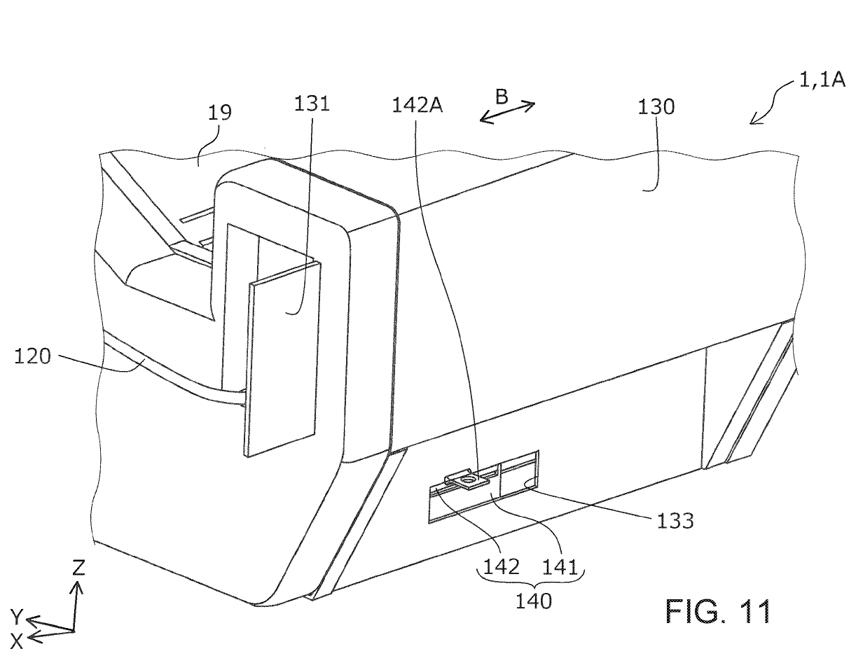

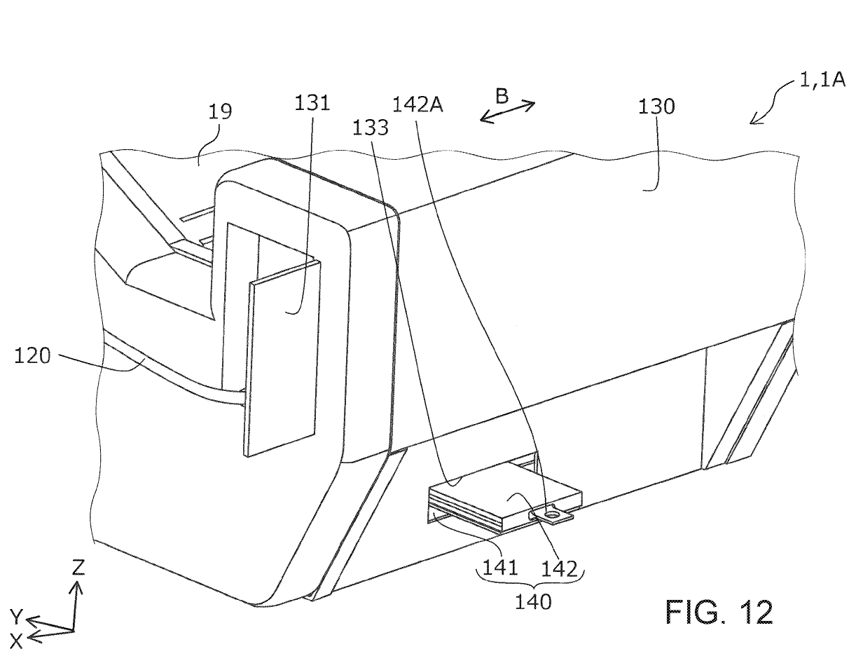

As illustrated in FIG. 11, the image reading device 1A of the present embodiment includes the filter 142 housed inside the housing 130. The filter 142 has a handle section 142A, and is attachable to and detachable from the housing 130 as illustrated in FIG. 12 by the user gripping the handle section 142A and pulling out it from an opening 133 provided in the back surface of the housing 130 along the -Y direction, specifically, the Y-axis direction as the depth direction, which is a direction intersecting the axial direction (X-axis direction) of the pivot shaft 73 illustrated in FIG. 1, and is a direction from the front surface toward the back surface of the housing 130.

In the image reading device 1A of the present embodiment, with such a configuration, the filter 142 can be easily cleaned or replaced without disassembling the device. Since the cleaning section 100 can be continuously used by cleaning or replacing the filter 142, for example, it is possible to reduce the number of times of handling by a service person or the like and it is possible to use the cleaning section 100 for a long period of time.

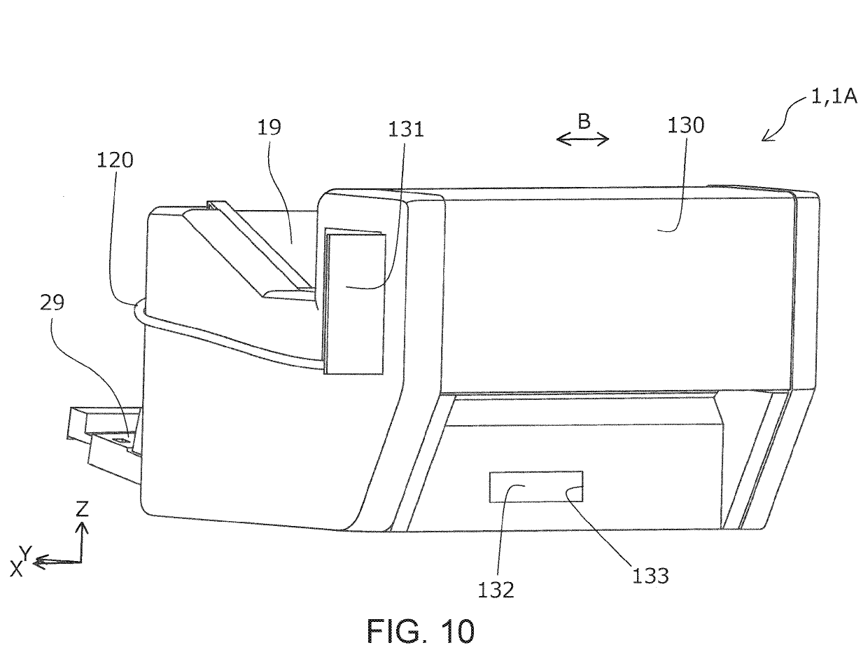

As illustrated in FIG. 10, in the image reading device 1A of the present embodiment, a cover member 132 is provided in a portion on the back surface side of the housing 130 in a normal state. The opening 133 is covered with the cover member 132. With such a configuration, it is possible to suppress foreign matter collected by the filter 142 from being diffused to the outside from the opening 133.

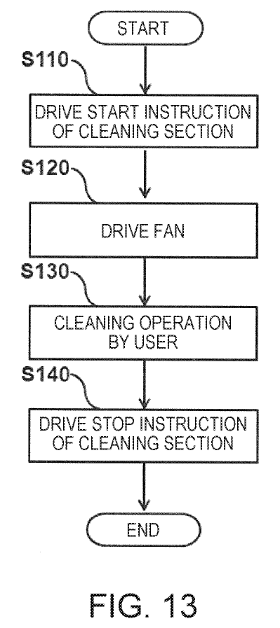

An example of a cleaning operation performed using the image reading device in FIG. 1 will be described below with reference to a flowchart in FIG. 13. In the cleaning operation shown in the flowchart of FIG. 13, first, in step S110, a drive start instruction of the cleaning section 100 is received from the user. At this time, for example, the user can select the energy saving mode, the normal mode, or the strong air-flow mode. The reception of the drive start instruction of the cleaning section 100 is performed by the user inputting an instruction on the operation panel 42, an external computer (not illustrated), or the like.

Next, the fan 141 is driven at step S120. Thereafter, the user performs a cleaning operation using the cleaning section 100 at step S130. After the user has sufficiently performed the cleaning operation using the cleaning section 100, a drive stop instruction of the cleaning section 100 is received from the user in step S140, and the cleaning operation shown in the flowchart of FIG. 13 is ended.

### Second Embodiment

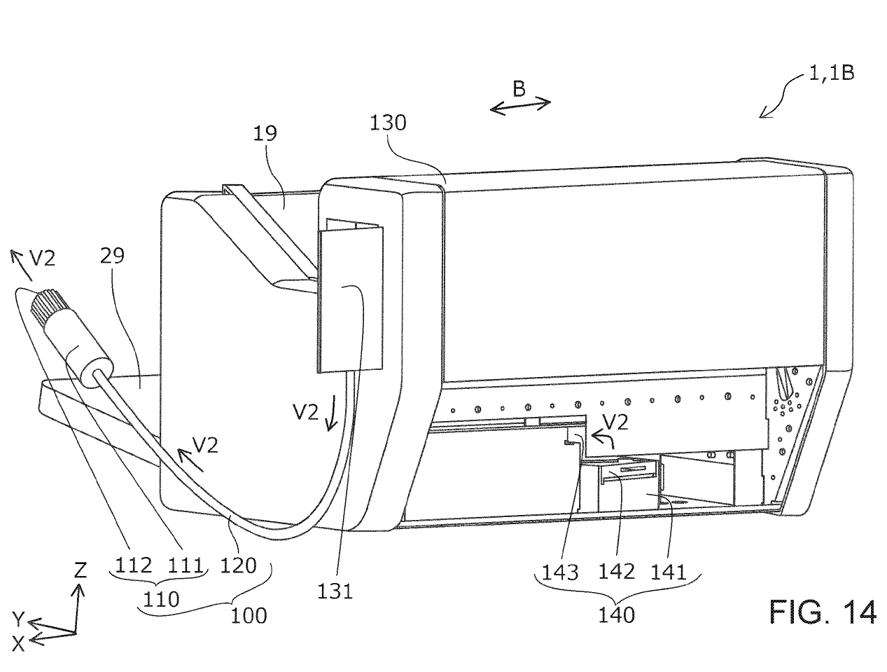

Next, an image reading device 1B according to a second embodiment will be described with reference to FIG. 14. FIG. 14 corresponds to FIG. 8 in the image reading device 1A of the first embodiment. In FIG. 14, components common to those of the first embodiment are denoted by the same reference symbols, and detailed description thereof will be omitted. The image reading device 1B of the present embodiment has the same configuration as the image reading device 1A of the first embodiment except for the direction of the airflow generated by the fan 141 of the airflow generation section 140. Therefore, the image reading device 1B of the present embodiment has the same features as the image reading device 1A of the first embodiment except for the parts described below.

As described above, the fan 141 of the airflow generation section 140 of the image reading device 1A according to the first embodiment is configured to generate the airflow to be sucked through the vent hole 113, and as illustrated in FIG. 8, the airflow is directed from the vent hole 113 to the fan 141 through the tube 120 and the duct 143 toward the suction direction V1. On the other hand, the fan 141 of the airflow generation section 140 of the image reading device 1B of the present embodiment is configured to generate the airflow discharged from the vent hole 113, and as illustrated in FIG. 14, the airflow is directed from the fan 141 to the vent hole 113 through the tube 120 and the duct 143 in a discharge direction V2.

That is, in the image reading device 1B of the present embodiment, the airflow generation section 140 generates airflow to be discharged from the vent hole 113. With such a configuration, when the amount of foreign matter adhering to the transport path 3 or the reading unit 5 is small, for example, when a small amount of foreign matter adhering to the reading unit 5 is to be removed, foreign matter can be moved to a position other than the reading unit 5 by blowing the airflow at foreign matter. Note that the filter 142 is also provided in the airflow generation section 140 in the image reading device 1B of the present embodiment as in the image reading device 1A of the first embodiment, the filter 142 may be omitted.

The present disclosure is not limited to the above described embodiments, and can be realized by various configurations without departing from the scope of the present disclosure. The technical features in the embodiments corresponding to the technical features in the respective aspects described in the summary of the present disclosure can be appropriately replaced or combined in order to solve some or all of the above described problems or in order to achieve some or all of the above described effects. If the technical features are not described as essential in this specification, the technical features can be appropriately omitted. For example, the image reading device may be configured to generate the airflow to be sucked through the vent hole 113 as in the image reading device 1A of the first embodiment and also to generate the airflow to be discharged through the vent hole 113 as in the image reading device 1B of the second embodiment.

What is claimed is:

1. An image reading device comprising:
a transport path along which a medium is transported;
a reading section configured to read an image of the transported medium;
a lower unit;
an upper unit that is provided so as to be openable and closable with respect to the lower unit by pivoting around a pivot shaft and that is configured to form a part of the transport path with the lower unit in a closed state;
a cleaning section configured to pass an airflow for removing foreign matter adhering to the reading section through a vent hole; and
an airflow generation section configured to generate the airflow in the cleaning section, wherein
the cleaning section is connected to the airflow generation section at a fixed end and is configured to remove foreign matter adhering to the reading section by the airflow at the vent hole, which is provided at a free end opposite to the fixed end.

2. The image reading device according to claim 1, wherein
the cleaning section is configured to remove foreign matter adhering to the transport path when the upper unit is in an open state.

3. The image reading device according to claim 1, wherein
the cleaning section includes a handle section that is provided at the free end and that has the vent hole and a flexible member that connects the airflow generation section and the handle section.

4. The image reading device according to claim 3, wherein
the flexible member has a length that allows cleaning of a portion of the reading section farthest from the fixed end in a width direction along a longitudinal direction of the reading section.

5. The image reading device according to claim 4, further comprising:
a placement section that is provided so as to be capable of being raised and lowered in a vertical direction and on which the medium to be transported to the transport path is placed, wherein
the flexible member has a length that allows cleaning of a portion of the transport path or the placement section farthest from the fixed end.

6. The image reading device according to claim 3, wherein
the handle section has a brush section at a distal end of the handle section and
the brush section is disposed around the vent hole.

7. The image reading device according to claim 1, further comprising:
a housing, wherein
the housing includes an accommodation section configured to accommodate the cleaning section inside the housing and a door section configured to cover the accommodation section in a state where the cleaning section is accommodated.

8. The image reading device according to claim 1, further comprising:
an operation section configured receive a cleaning instruction, wherein
a first cleaning mode, a second cleaning mode, and a third cleaning mode are executable in order of weaker airflow generated by the airflow generation section and
when the operation section receives a cleaning instruction, the operation section is configured to display a selection of modes that select one of the first cleaning mode, the second cleaning mode, and the third cleaning mode.

9. The image reading device according to claim 1, wherein
the airflow generation section includes a fan configured to generate the airflow, and a duct configured to connect the fixed end and the fan.

10. The image reading device according to claim 9, wherein
the fan is provided at a position closer to the fixed end than a half of a width of the image reading device in the width direction along a longitudinal direction of the reading section.

11. The image reading device according to claim 9, wherein
the airflow generation section is configured to generate the airflow to be sucked through the vent hole.

12. The image reading device according to claim 11, wherein
the airflow generation section includes a collection section configured to collect foreign matter sucked from the cleaning section and
the collection section is disposed between the duct and the fan.

13. The image reading device according to claim 12, further comprising:
a housing configured to accommodate the collection section therein, wherein
the collection section is configured to attach to and detach from the housing by being pulled out from an opening provided in a back surface of the housing along a depth direction that is a direction intersecting an axial direction of the pivot shaft and is a direction from a front surface of the housing toward the back surface.

14. The image reading device according to claim 13, wherein
the opening is covered with a cover member.

15. The image reading device according to claim 9, wherein
the airflow generation section is configured to generate the airflow to be discharged from the vent hole.
